(19) United States
(12) Patent Application Publication
(10) Pub. No.: US 2025/0369866 A1
(43) Pub. Date: Dec. 4, 2025

(54) PARTICLE DETECTOR

(71) Applicant: Inficon Inc., East Syracuse, NY (US)

(72) Inventors: Michael Haggmark, Manlius, NY (US); Silvio Decker, Koln (DE)

(21) Appl. No.: 19/223,816

(22) Filed: May 30, 2025

Related U.S. Application Data
(60) Provisional application No. 63/653,267, filed on May 30, 2024.

(51) Int. Cl. G01N 15/1434; G01N 15/0205; G01N 15/14

(52) U.S. Cl. CPC G01N 15/1436; G01N 15/0211; G01N 2015/1493

(57) ABSTRACT

A system for particle detection within a chamber includes a transmitter configured to generate a beam of light, one of a multipass configuration and beam shaping optics associated with the laser for generating a beam area within the chamber, the beam area configured to be arranged at an oblique angle relative to a longitudinal axis of the chamber and substantially confined to an imaging plane, and a detector configured to detect particles illuminated by the beam of light at the imaging plane. A method for detecting and measuring particles previously deposited on a surface of a semiconductor manufacturing chamber is also described.

### CROSS REFERENCE TO RELATED APPLICATION(S)

The present application claims the benefit of and priority to U.S. Provisional 63/653,267 filed May 30, 2024, title PARTICLE DETECTOR, the entire contents of which are hereby incorporated by reference herein.

### FIELD OF THE INVENTION

The present invention relates to the field of semiconductor wafer processing. In particular, the present invention relates to a system and method for analyzing signals resulting from a laser beam particle monitor.

### BACKGROUND OF THE INVENTION

Particles are a huge problem in a variety of devices and fields. For instance, with semiconductors where there are costly detrimental effects on yield and reliability, and with optics and display where there are problems in quality. Particle contaminants in semiconductor fabrication equipment such as plasma etch and vapor deposition chambers can deposit on semiconductor wafer surfaces and cause manufacturing defects that reduce the yield of operable devices. Such small particles typically originate from deposition of a process film onto the process chamber walls. When the film becomes too thick or develops high internal stresses, the film can flake off of the walls forming free particles. If the particles end up on the wafer surface the semiconductor processing process can be adversely affected. In worst case particle contamination of a wafer, part or all of the wafer can no longer be used. Detecting particles early in the wafer manufacturing process is desirable because this information can be used to scrap or rework damaged wafers rather than continue to process wafers with defects. Detecting particles can also be used to trigger a chamber clean, which uses an etch chemical and plasma to remove thin films from walls before extensive particles can form. Chamber cleans are costly and slow down the process. The chamber, for example, may require a re-seasoning step before continuing. Therefore, it is desirable to clean the chamber no more often than what is required to maintain desirable processed wafer manufacturing yield.

The semiconductor process takes many dozens of steps. A wafer may be processed through many additional and expensive steps after the particles contaminated the surface and degrade yield of the finished devices. Between process steps, particles can be detected by ex situ detection methods. However, the ex situ detection processes are expensive and can slow down the manufacturing process. The ex situ detection processes are not a perfect representation, because particles can be unintentionally moved off of or onto the wafer in the handling operations.

In situ particle monitoring sensors can provide continuous monitoring of particulate contamination levels during key semiconductor process operations and, in many applications, are preferable to ex situ detection. Based upon light-scattering detection techniques, the in situ sensors are typically installed downstream of the process chamber, such as to a pump-line, and provide real-time measurement of variations in particle concentration and size during wafer processing. However, there are several inherent disadvantages to pump-line sensor installation. First, a particle depositing on a processed wafer cannot be measured with the sensor in the pump-line configuration. Second, and because in situ sensors depend on various particle transport mechanisms to detect the particles generated upstream in the process chamber, in situ sensor applications often produce poor correlation with the number of particles that deposit directly on the product wafer surface. Third, the particle detection volume for in situ sensors is also limited by the small cross-sectional area of the laser beam which is illuminating the particle(s). Fourth, measurement typically must be performed at a location far away from the wafer or flat panel being processed. A close in location, such as directly above the wafer seems attractive; however, physical access to space close to the wafer is limited. In addition, semiconductor and flat panel processes often employ plasma, which can cause optical and electrical noise. Moreover, many relevant processes are deposition processes which can quickly degrade sensor windows.

Some of these tools have huge fore lines, such as 200 mm pump lines. The issue with measuring such a large area is that the particle has to fly through a small laser beam (typically a few mm) in order to be detected. The probability of that rapidly declines as the pipe expands, given a constant detection area. Thus, a large detection area is necessary when working in environments with few particles distributed over a large fore line cross section.

A discontinued product made available by the assignee, INFICON, marketed as Stiletto, achieved wide area coverage with a scanning mirror and a fast detector.

It has the advantage of being able to cover a wide area and confirm counts of slow particles. Unfortunately, the scanning mirror is relatively expensive.

The In-Line Particle Sensor™ made available through Nordson does not have any scanning and instead uses a laser ribbon. It operates by spreading out the beam and detecting particles that fly though what appears to be a relatively narrow area in one fixed size, an ISO63 flange. It is disposed to one end of the pump line where the port is. A laser ribbon works but requires a higher power laser as the beam is fanned out. Also, despite fanning out, it does not appear to cover that substantial of a segment of the pipe from images made publicly available.

Both the INFICON Stiletto and Nordson In-Line Particle Sensor™ use fast detectors, which can miss particles because they are too fast.

What is needed is an improved particle detector system and method for detection of particles that can achieve a large detection area without the disadvantages of the prior art devices.

### SUMMARY OF THE INVENTION

To overcome the drawbacks in the known devices and to achieve at least some of the above-stated objectives, a particle detector system is provided, which includes an imaging detector (camera) with a set of optics that localizes the laser beam along an approximately planar volume. The planar volume is disposed at an angle relative to the cross section of the pump line. The planar volume can be generated by the appropriate multipass configuration or by fanning out with beam shaping optics such as cylindrical lenses. The camera is able to detect light from the particles that pass through the laser. The detector achieves a wide area coverage with a fraction of the laser power needed by a fanning out approach, which also means that higher power implementations can attempt to look for other signals as well, such as emission from the particles (fluorescence or otherwise).

The inventive particle detector system may encompass or cover nearly about 2 inch or 50 millimeter (mm) swath—as opposed to the typical several mm diameter of a laser beam. This provides a well-matched detection efficiency to typical vacuum applications and may have uses elsewhere as well.

In one exemplary embodiment, a system for particle detection within a chamber includes a transmitter configured to generate a beam of light, one of a multipass configuration and beam shaping optics associated with the laser for generating a beam area within the chamber, the beam area configured to be arranged at an oblique angle relative to a longitudinal axis of the chamber and substantially confined to an imaging plane; and a detector configured to detect particles that interact with the beam of light at the imaging plane.

In some embodiments, the system includes the multipass configuration with at least one of a curved mirror, a retroreflective mirror, and a combination thereof. In additional embodiments, the system includes the beam shaping optics configured to generate a rectangular ribbon shape of light.

In certain embodiments, the oblique angle is in a range from about 30 degrees to about 60 degrees.

In some embodiments, the chamber has an inner diameter, and the beam area extends through about 25% to about 90% of the inner diameter of the chamber. Additionally, the system is configured to match the beam area to an inner diameter of the chamber.

In certain embodiments, the system is configured to detect a particle size of less than about 100 nm using optical emission.

In some embodiments, the detector is configured to provide spatial information about the detected particles.

The transmitter may be configured to be mechanically coupled to a wall of the chamber and optically coupled via a transmitter window to transmit the beam of light to the chamber, and the detector may be configured to be mechanically coupled to the wall of the chamber and optically coupled via a detector window to receive light from the particles as they pass through the beam area.

A system for particle detection within a pipe is also provided, including a transmitter configured to generate a beam of light, a multipass configuration associated with the laser, wherein the multipass configuration has at least one of a curved mirror, a retroreflective mirror, and a combination thereof, and wherein multipass configuration generates a beam area within the pipe arranged at an oblique angle relative to a longitudinal axis of the pipe, and a camera configured to detect one or more particles that traverse the beam area and interact with the beam of light, wherein the camera is positioned substantially perpendicular to the imaging plane.

In some embodiments, the beam area is substantially confined to the imaging plane.

In certain embodiments, the system is installed in a section of a vacuum pump line fluidly connecting a process chamber with a vacuum pump system. In some of those embodiments, the section of the pipe has a mounting assembly that connects a first end of the pipe section to the process chamber and connects a second end of the pipe section to the vacuum pump system.

A method for particle detection within a chamber is further provided including the steps of emitting a beam of light via a laser source into the chamber, generating a beam area in the chamber by one of fanning out the beam of light or utilizing mirrors to generate a multi-pass structure, tilting the beam area such that it is arranged at an oblique angle relative to a longitudinal axis of the chamber, substantially confining the beam area to an imaging plane, and detecting, with a detector, particles that interact with the beam of light at the imaging plane.

In some embodiments, the step of generating the imaging plane includes utilizing the multi-pass structure having at least one of a curved mirror, a retroreflective mirror, and a combination thereof, wherein the beam of light is bounced back and forth within the beam area a plurality of times.

In certain embodiments, the oblique angle is in a range from about 30 degrees to about 60 degrees.

In some cases, the step of matching the imaging plane to an inner diameter of the chamber is also included.

The method may include detecting one or more particles with a particle size of about 100 nm or less via the detector by detecting light emitted by the one or more particles that interact with the beam of light using optical emission.

In some embodiments, there is a further step of providing spatial information about the detected particles via the detector.

In certain embodiments, the detector is positioned substantially perpendicular to the imaging plane to detect a light scattered from the detected particles that traverse the beam area.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a partially cross-sectional view of a prior art device for particle detection.

FIG. 2 is a diagram of a semiconductor tool of another prior art device for particle detection.

FIG. 3 is cross-sectional view of a further prior art device for particle detection.

FIGS. 4A and 4B illustrate a particle detection system in accordance with one or more illustrative embodiments of the present invention.

FIG. 5 illustrates a multi-pass system in accordance with one or more illustrative embodiments of the present invention.

FIG. 6 illustrates a particle detection system in accordance with one or more illustrative embodiments of the present invention.

FIG. 7 illustrates a light beam diagram for the particle detection system in accordance with one or more illustrative embodiments of the present invention.

### DETAILED DESCRIPTION

In situ particle detection is more desirable than ex situ detection for the reasons mentioned above. In situ particle detection typically utilizes a low-divergence light source to generate a directed light beam to produce scattered light when impinging upon particles for sensing purposes. Low-divergence light sources include gas lasers, solid-state lasers fiber lasers, liquid or dye lasers, semiconductor lasers (laser diodes), low-divergent LED (light-emitting diode). Laser optical light sources are specifically mentioned. In the present disclosure, the term “light source” refers to a low-divergence source of light including, but not limited to, a laser light source.

A scanning laser or fanned out beam of a higher power laser are two suitable approaches for in situ particle detection. The laser light is scattered from the particle and detected with a suitable photon sensitive device. This can be one of a photo multiplier tube (PMT), an avalanche photo diode (APD), or a camera such as a CMOS array. The most probable direction of scattered light is predicted by particle size, particle make-up (index of refraction), and laser wavelength as described by the Mie Theory. Some references disclosing particle detection are described in U.S. Pat. Nos. 5,943,130; 6,906,799; and 10,801,945, and U.S. Publication No. 2024/0159641, the entire contents of these documents being incorporated by reference herein. Noise is often limited by light scattered from the windows and beam dump and thus, a forward scattering direction is often preferred.

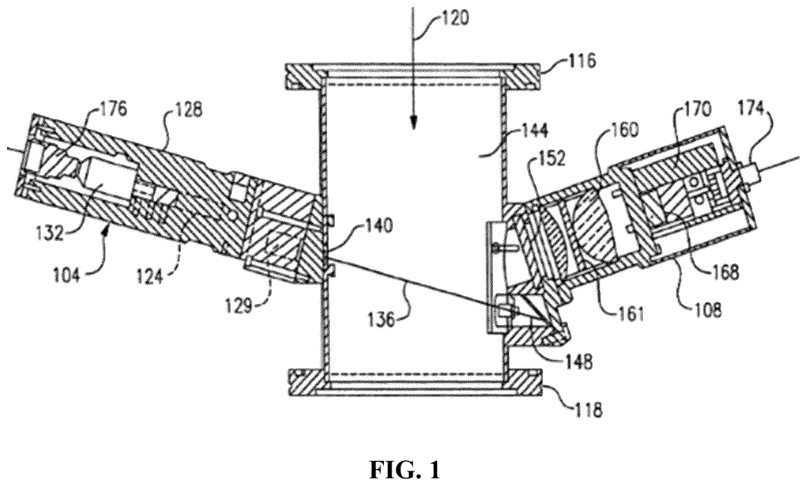

FIG. 1 is a cross-sectional view of a prior art in situ particle detector described in U.S. Pat. No. 6,906,799. It uses a scanning mirror and a fast detector to cover a large area. It has the advantage of being able to cover a wide area and confirm counts of slow particles. However, it has the added complexity of tracking the mirror/beam position, a fast detector, and missing very fast particles due to the limitations of mirror speed.

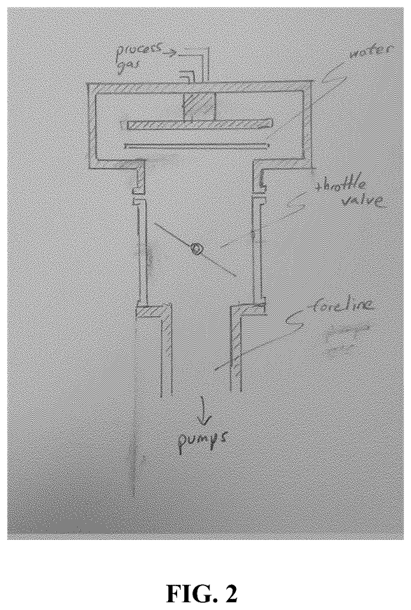

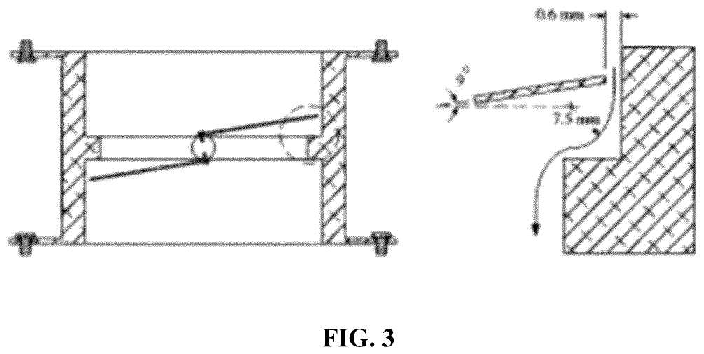

Most modern semiconductor processes operate at high and low vacuum conditions. Under high vacuum conditions, the chamber connection is opened fully to a pump. In this context, low vacuum may mean 0.1-100 Torr and high vacuum may mean<0.0001 Torr. High vacuum is preferrable to remove residual species from a previous process or after a preventative maintenance cycle. But low vacuum is necessary to maintain the process conditions suitable for sputtering or plasma facilitated processes of most modern deposition and etch processes. To maintain vacuum, the process chamber is typically connected in some way to a pump. The connection typically makes use of a variable throttle valve—often a butterfly valve—to adjust the pumping speed and maintain the desired process pressure in the chamber. FIGS. 2 and 3 illustrate tools exhibiting wafer and throttle valve arrangements in the prior art.

Direct installation of a laser-based particle sensor may be possible on the chamber's exhaust line (i.e., fore line or pump line). Installation on the pump line or fore line is advantageous because the sensor can be added to a complete semiconductor tool—or a range of tools—with minimal modification. A concern for installation of particle sensor on the exhaust lines is the measured particle flux passing through a region of the fore line may not be well correlated with the particles that damage the wafer. As the distance from the wafer to the sensor increases, this correlation decreases further because particles fall out of the gas flow due to gravity, sticking, or other mechanisms. Additionally, the particle flux falls as the gas flow moves through larger diameters of the exhaust lines. High particle flux near the throttle valve would be a preferred place to do detection; however, installation below the throttle valve is problematic because the regions of highest particle density change as the throttle valve is actuated—which is typically controlled with a feedback loop to maintain a target process pressure. This causes noise and missed particles.

In accordance with illustrative embodiments of the present invention, a particle detection system utilizes an imaging detector, for example, a camera with a multi-pass cell that localizes the laser beam along an approximately planar volume. The camera is able to detect light from the particles that pass through the laser. It achieves wide area coverage without moving parts with a fraction of the laser power needed by the fanning out approach. This means that higher power implementations can attempt to look for other signals as well, such as emission from the particles (fluorescence or otherwise). The system and method of the present invention avoid the use of costly scanning mirror or large format lasers and match the detection area to pipe size by having an easily attainable large detection volume.

The particle detection system of the present invention may be fluidically interposed between a process chamber and vacuum pump on vacuum pump line, e.g., process chamber exhaust line. In some embodiments, the system may be positioned outside of the process chamber and before the vacuum pump. In other embodiments, the system may be mounted to the process chamber or other suitable semiconductor processing tools/environments. In additional embodiments, the system may be fluidically interposed on a vacuum line between high and low vacuum pumps. Further, the system may be located in the exhaust line from the low vacuum pump to atmosphere.

In some embodiments, a particle detector housing may be a section of pipe or tubing or other suitably equivalent enclosure. The particle detector may be removable as a unit for installation, periodic or diagnostic maintenance, or replacement. Any suitable removable mounting apparatus, such as a flange and a fastener, may be used to connect the housing to the piping, for example a cut out in existing piping or an extension of existing piping. Such design allows the particle detector to be both retrofitted into existing operational semiconductor tools as well as new tool designs specifically incorporating an embodiment of the present technology. In additional embodiments, the particle detector may be installed in a by-pass configuration where the particle detector is installed in a gas flow line (bypass pipe) that is parallel with the main pipe.

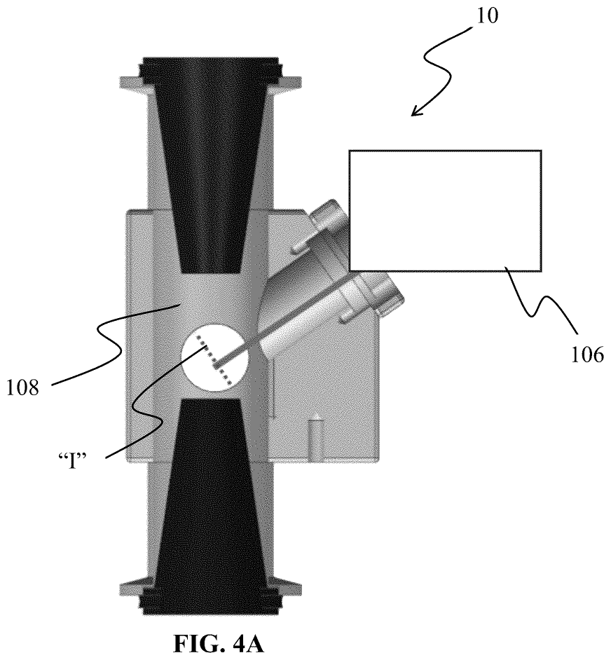

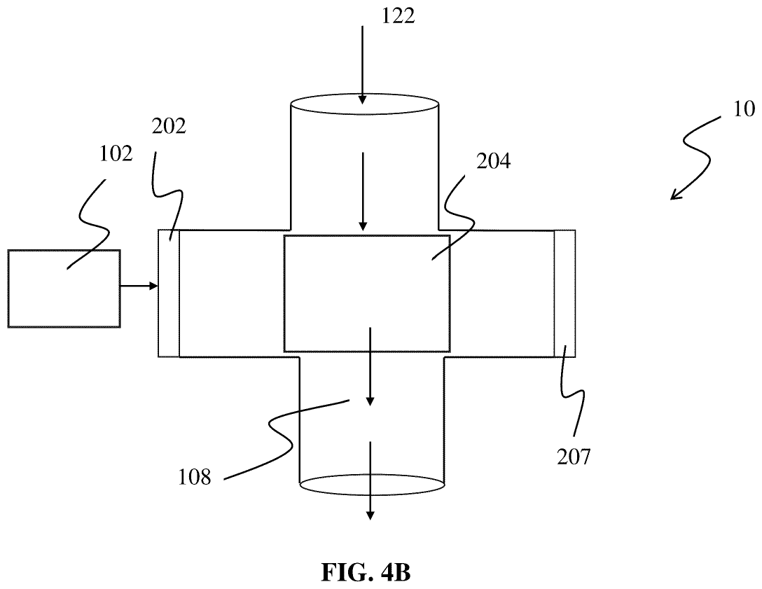

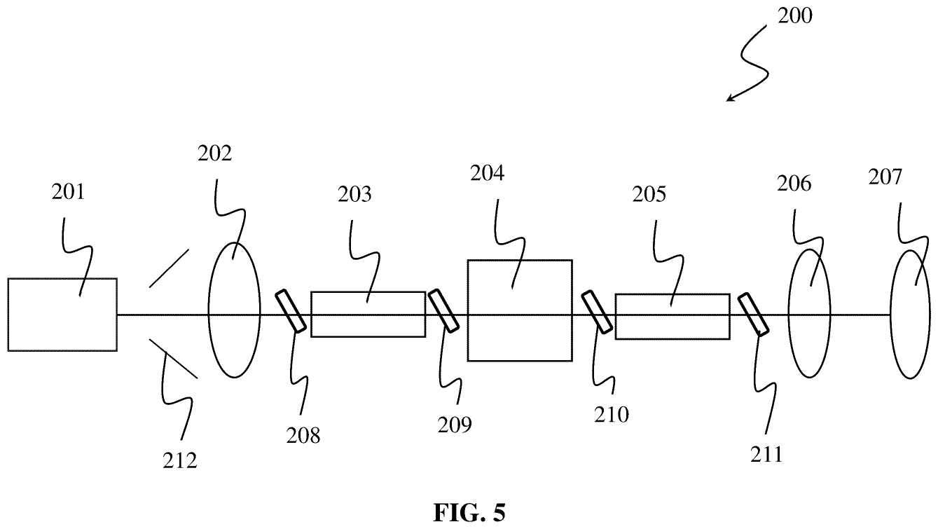

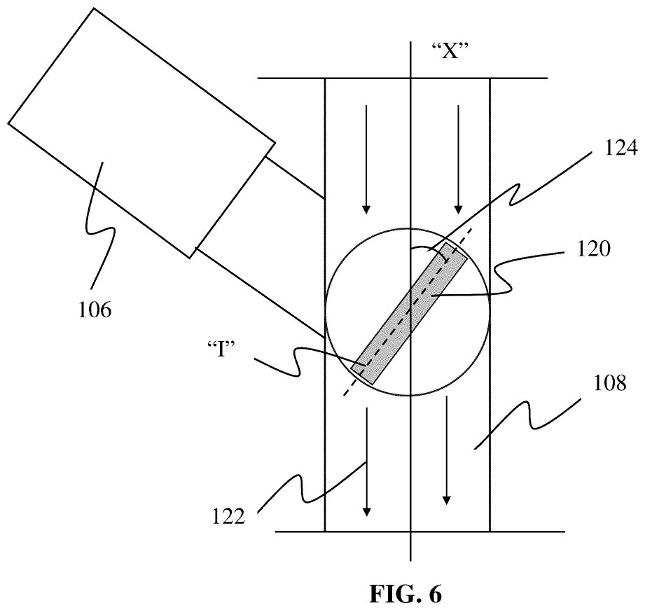

With reference to FIGS. 4A, 4B and 6, schematic views of one exemplary embodiment of a particle detection system 10 in accordance with the principles of the present invention are illustrated. A transmitter 102, such as a laser diode, emits a beam(s) of light to a variety of focusing optics, which direct the light beam(s) to a multi-pass structure or cell 104, which is in fluid communication with the pipe 108. The transmitter 102 may be arranged within a housing and the beam of light may exit the transmitter through a window provided in the housing. In some embodiments, the laser source is configured to emit a wavelength from UV to about 480 nm. The multi-pass cell 104 uses a system of mirrors, shown in more detail in FIG. 5, adapted to repeatedly deflect the beam of light through a pipe 108, for example, a fore line, containing a gas or particle-containing volume. In some embodiments, the pipe 108 has an inner diameter of about 40 mm to about 200 mm. The multi-pass cell 104 is arranged such that it generates an imaging plane “I” that is angularly offset relative to an axis “X” of direction of the pipe 108—i.e., a longitudinal axis “X” of the pipe—for detection by an optical detector 106, such as a photo multiplier tube (PMT), an avalanche photo diode (APD) or a camera, as shown in FIG. 6. In some preferred embodiments, a camera with CMOS or CCD chip is used as the optical detector. In some exemplary embodiments, the angle 124 between the imaging plane “I” and the longitudinal axis “×” of the pipe 108 is an oblique angle. In some embodiments, the angle 124 is around 10 degrees to around 80 degrees, or around 20 degrees to around 70 degrees, or around 30 degrees to around 60 degrees.

The optical detector 106 is positioned such that its sensor plane is optically conjugate to the imaging plane. In other words, the camera optics—such as lenses or objectives—are arranged in a way that brings the imaging plane into sharp focus on the camera's detector (CMOS or CCD chip). In this arrangement, every point in the imaging plane corresponds precisely to a point on the camera sensor, preserving spatial details like particle positions, beam structure, or intensity gradients. In some preferred embodiments, the camera 106 is placed substantially perpendicular to the imaging plane “I”. This orientation helps minimize detection of stray light, and it allows the camera to clearly image the illuminated particles from the side. The most probable direction of scattered light can be predicted by particle size, particle make-up (index of refraction), and the laser wavelength, for example, as described by the Mie scattering theory. In some embodiments, an angle between an axis of light beam transmission from the optical transmitter 102 and the orientation axis of the optical detector 106 is about 90 degrees. Although such design may yield a weaker signal, it produces a signal that is more uniform across particle sizes and is more efficient in collecting imaging data from a large area. Other embodiments with a 30-degree angle are also envisioned.

The multi-pass 104 is configured to generate a plane to image from, which is disposed in the flow path 122 of particles. In the fore line implementation, the beam is in/out of the plane and generates an image plane for the camera. Moreover, for a particle falling down, it is quite difficult to miss the beam if passing through the detection area, as illustrated in FIG. 6. In general, the multipass cell has first and second reflector arrangements. The reflector arrangements are arranged such that light entering the multipass cell is repeatedly reflected between the two arrangements (without being reflected from any surfaces other than the surfaces of the two reflector arrangements) and the reflector arrangements define a beam area.

FIG. 5 illustrates one exemplary embodiment of a multi-pass structure or cell 200 in accordance with the present invention. At the far left of the system, a laser source 201 emits a beam of light into the multipass cell 200. The cell has a pair of angled retro-reflector (RR) mirrors 212 which act to redirect light back through the cell along a defined path. The retro-reflective function is important in achieving multiple beam passes within the system without complex mirror arrangements. The retro-reflector mirrors 212 are arranged such that there is a passage between the two mirrors where the light beam enters the system. The system is set up such that the incoming laser beam enters the multipass cell at a specific angle between the direction of the light beam and a longitudinal axis of the cell. Exemplary angles are between about 2 degrees to about 10 degrees. This setup ensures that after reflection, the beam returns along a slightly offset path instead of exactly retracing its incoming route, which is the key to achieving multiple discrete passes. When the beam is sent straight into the cell, it would likely return directly on top of itself, causing interference and/or signal contamination.

The angled mirrors 212 offset the beam spatially, allowing each pass through the sample volume to follow a slightly different path. The mirrors 212 may be adjustable to make it easier to fine-tune the alignment of the laser into the retroreflector and optimize the number of effective passes. The types, angles and positions of the mirrors are chosen as desired depending on how the light crisscrosses the cell and how many times it interacts with the sample. In some embodiments, the mirrors 212 are plane mirrors. In other embodiments, the mirrors 212 are prism mirrors.

Next, the light beams pass through a window 202 which serves as the vacuum-sealed optical entry point into the system. The window 202 may be of any suitable size and material depending on the desired configuration and may be transparent to the selected wavelength of the light source. In some embodiments, the mirror is about 2 inches (50 mm). In some embodiments, the mirrors 212 may be positioned on the other side of the window 202 inside vacuum chamber. The light beam then travels through a fitting 203, such as, e.g., KF50 arm 203, which is a tubular vacuum component that maintains alignment and vacuum integrity, or another suitable fitting. The fitting may be formed of any suitable material including, but not limited to, stainless steel and aluminum. The fitting 203 may be equipped with a purge port, which allows inert or dry gases to flow in, protecting sensitive optical components from contamination or condensation. One or more optical baffles 208 and 209 are positioned on the fitting 203. The optical baffles function to suppress stray light that could cause noise, flare, or ghost signals in the optical path and prevent reflected or scattered light from bouncing around and reaching the optical detector indirectly.

Next, the beam of light enters the main body 204 of the multi-pass cell—the core of the system where the particles flow through. The body 204 is positioned inside the pipe 108 and is fluidly connected to the pipe through an inlet and outlet port, such that gas flow and particles flowing through the pipe pass through the body 204, as shown in FIG. 4B. The light beams bounce back and forth through the body 204 where they encounter the particles falling through the pipe 108 and illuminate them. The body 204 also has a window that transmits light to the optical detector 106 for analysis. Internal walls of the cell body 204 may be subjected to surface treatment, such as anodized black, to reduce the amount of light reflected. The cell body 204 may be connected to KF40 flanges or another suitable connector, which may be used for additional vacuum connections, gas inputs, or monitoring equipment.

After traversing the cell body 204, the beam exits through another KF50 arm 205 or another suitable fitting, which, like the first, may contain a purge port. This ensures that both the entry and exit optics remain clear and free of contaminants. The fitting 205 supports one or more additional optical baffles 210 and 211 which function in the same way as described above. The light beam then exists to another mirror 207, which may be a curved mirror, such as a concave mirror. The mirror 207 is used to deflect the light beams back through the cell body 204 and onto the RR mirrors 212, such that the light beams can bounce back and forth through the multicell multiple times. Another optical window 206 may be positioned before or after the mirror 207 to provide a vacuum seal to the multipass system. The mirror 207 reflects and focuses the light back towards the pair of RR mirrors 212. The light reflects from one of the mirrors 212 to the other of the mirrors 212. The mirrors 212 may be positioned such that their faces are substantially perpendicular such that the light is retroreflected by the combination of the two mirrors 212 back towards the mirror 207. The relational positioning the mirrors 212 and mirror 207 causes the light to follow a stable specific path within the cell 200. After a number of reflections within the beam area, the path of the light will eventually cross the opening between the mirrors 212 such that the light will emerges from the cell 200.

The system shown in FIG. 5 may utilize a variety of planar or curved optical mirrors that direct of reflect the light beam as it travels through the multi-pass system. The mirrors 212 are positioned to steer the laser beam through the cell 204 at the proper angle. This alignment is important to ensure the beam enters the optical cavity in a way that allows for multiple internal reflections. Additional mirrors may be positioned within the cell body 204 to work together to create a bouncing light beam path. This internal configuration allows the beam to reflect repeatedly through the sample volume, significantly increasing the interaction length and enhancing measurement sensitivity.

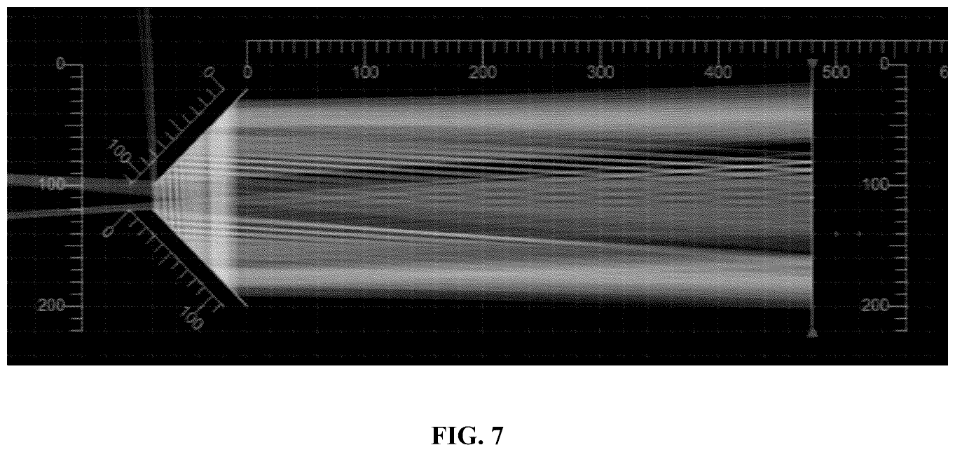

It is understood that the arrangement illustrated in FIG. 5 is only exemplary and that other multi-pass system arrangements may be used to achieve the objectives of the present invention. Some exemplary embodiments of a multipass cell system are described in U.S. Pat. Nos. 12,235,207 and 7,307,716, the disclosures of which are incorporated hereto in their entirety. In general, the multi-pass system may utilize a mix or curved and/or retroreflective mirrors and/or lenses to allow the light beam(s) to bounce back and forth within a confined space of two or more mirrors. FIG. 7 illustrates an exemplary light beam diagram for the multi-pass system arrangement of the present invention.

The multi-pass system arrangement is advantageous in that it allows for higher laser power density in the particle detection region compared to the systems that spread out the laser power. This in turn allows for possible light emission detection, such as fluorescence and possibly incandescence.

In alternative embodiments of the present invention, a laser light sheet may be provided instead of the multi-pass system. In these embodiments, a light beam(s) emitted by the laser 102 may be “fanned out” using various optics such as a cylindrical lens or a Powell lens. A cylindrical lens is curved in only one direction, which allows it to expand or focus the beam along a single axis. When placed in the path of a collimated laser beam, it stretches the beam into a thin, elongated line of light. However, this line typically has a non-uniform intensity profile—the beam tends to be brighter at the center and dimmer at the edges, which may not be ideal for precision measurements that rely on uniform illumination. To overcome this limitation, a Powell lens may be used instead. A Powell lens also converts a collimated beam into a line, but it creates a much more uniform intensity along that line. It does this by introducing a controlled optical aberration that redistributes the beam's energy evenly across the entire span. As a result, the beam becomes not just a line but a consistent sheet of light. By expanding the beam, the system ensures that more of the particle volume is probed and the detection area is more evenly covered. This optical approach also allows for easier alignment between the shape of the beam and the geometry of the detection setup. In other words, since the camera has a planar detection area, the fanned-out beam can be matched to it, improving signal-to-noise ratio and measurement reliability. An additional cylindrical lens is provided to re-collimate the beam after the first cylindrical lens and/or the Powell lens. The system is arranged such that the fanned out beam generates an imaging plane within a chamber, where the imaging plane is arranged at an oblique angle relative to a longitudinal axis of the chamber, as discussed above.

The system may further include a controller that collects and stores signal information from the camera 106 and processes the signal information to provide an output indicative of qualitative and/or quantitative information on particles flowing through the chamber 108. Additionally, controller may also be connected to various additional particle sensors disposed on other exhaust lines or fluid conduits in order to obtain a more comprehensive indication of particle flow relative to the semiconductor tool (e.g., process chamber). Such design may provide for a more complete sensing of particle presence in the line while not requiring a single larger and more complex sensing structure.

The inventive particle detection system is configured to match the size of the fore line 108 or another sample chamber to the detection area. Otherwise stated, the multi-pass system creates an imaging plane, e.g., a tilt/imaging plane “I”, with the camera 106 arranged at an angle that allows flow through the fore line 108 without bends. The system matches the detection volume—i.e., the region where the light is expected to interact with the sample and then exit toward a detector (i.e., a camera)—to the size of the fore line 108 such that the detection volume occupies a substantial volume or inner diameter of the fore line 108. As shown in FIG. 6, the beam volume 120 occupies a substantial area or volume of the fore line 108 thereby increasing the potential for detection of particles which would otherwise pass undetected. In some embodiments, the beam volume 120 occupies about 10% to about 100% of the inner diameter of the fore line 108, or about 20% to about 80% of the inner diameter, or about 30% to about 70% of the inner diameter, or about 25% to about 90%, or more than about 40% of the inner diameter, or more than about 50% of the inner diameter, or more than about 75% of the inner diameter, or at least about 25%.

The camera 106 may be configured to remove or reduce noise due to spatial resolution by enabling spatial filtering by allowing the system to resolve and separate the true optical signal from unwanted light based on where the light is coming from in space. The camera records a full 2D image of the light pattern coming out of the optical system. Every pixel in the camera corresponds to a different spatial location and this spatial information may be used to isolate the laser beam spot or desired emission region. There may be stray light, scattered light, or background glow from outside the intended beam path. The camera may be configured to detect these spatially offset noise sources and allow the system to ignore pixels where there is only noise and analyze only the region where the signal is well-focused and relevant (e.g., the beam waist or central path). This improves the signal-to-noise ratio (SNR) produced by the system. In a multi-pass cell, the beam may make many reflections that show up as multiple spots or lines on the detector. The camera may be configured to selectively analyze specific passes or regions and identify and subtract out-of-plane reflections or scattered light. In one exemplary embodiment, the data is analyzed by analyzing the change in pixel values between imaging frames due to the transient nature of a particle passing through the beam.

The particle detection system of the present invention operates by generating a large coverage area in a chamber by fanning out the beam or utilizing mirrors to generate a multi-pass structure. The coverage area serves as an imaging plane for a detector, such as a camera. The coverage area is arranged such that it is positioned at an oblique angle relative to a longitudinal axis of the chamber. The particles illuminated by the laser at the imaging plane are then detected by the detector.

The particle detector system and method of the present invention provide many advantages, including:
i) a large area coverage is achieved without moving parts;
ii) the multi-pass arrangement is quite stable against vibration and allows the possibility of enabling large power to enter into the system, which in turn allows for particle scattering and possibly light emission detection (for <100 nm particles);
iii) provides spatial information and opportunity for mapping;
iv) the combination of camera and multi-pass;
v) the camera allows removal of noise due to spatial resolution;
vi) the camera provides spatial information to assist in identifying a typical problem area within a system, e.g., useful on an insertion probe style sensor to look for the source of particle problems;
vii) matches the detection area to pipe size by having an easily attainable large detection volume;
viii) avoids costly scanning mirror; and
ix) provides a huge dynamic range—from single particles per frame to multitude particles to frame.

Embodiments of the particle detection system and method, as described hereinabove, may also include electronics, such as, for example, an optional analog to digital converter connected to the optical detector 106 and optional conditioning circuitry operatively coupled to a processor. Some alternative types of suitable detectors can include integral electronics which provide a digital output. Any suitable analog or digital detector can be used for optical detection of the particle flow. The processor may also be operatively coupled to a pressure sensor in the pipe 108 disposed between the process chamber and the particle detection system, the light source 102 through an electrical connection to a light source coupler operating through a conductor; and through a connection to a vacuum pump, or similar functional equivalents, to name only one possible combination of sensor, actuator and control components. The processor may further be configured to run a software process to generate particle information based on data received from the optical detector. In some embodiments, the processor can also control any suitable parameters of the light source 102, including any adjustable optics in the optical path of the light source 106, such as beam size, beam shape, beam width, beam focus, beam intensity, to name only a few exemplary operational parameters.

A software to model and operated the particle detection system according to the present disclosure, including new processes, can be supplied on a computer readable non-transitory storage medium. A computer readable non-transitory storage medium as non-transitory data storage includes any data stored on any suitable media in a non-fleeting manner. Such data storage includes any suitable computer readable non-transitory storage medium, including, but not limited to hard drives, non-volatile random-access memory (RAM), solid state drive (SSD) devices, or the functional equivalents.

The term “about” is to be construed as modifying a term or value such that it is not an absolute. This term will be defined by the circumstances. This includes, at the very least, the degree of expected experimental error, technique error and instrument error for a given technique used to measure a value. In general, this term used in connection with a numerical value throughout the specification and the claims denotes an interval of accuracy, familiar and acceptable to a person skilled in the art. In general, such interval of accuracy is ±10%. Thus, “about ten” means 9 to 11. All numbers in this description indicating amounts, ratios of materials, physical properties of materials, and/or use are to be understood as modified by the word “about,” except as otherwise explicitly indicated.

The terms “a” and “an” do not denote a limitation of quantity, but rather denote the presence of at least one of the referenced item.

The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments.

“Optional” or “optionally” means that the subsequently described event or circumstance may or may not occur, and that the description includes instances where the event occurs and instances where it does not.

The terms “first,” “second,” and the like, “primary,” “secondary,” and the like, as used herein do not denote any order, quantity, or importance, but rather are used to distinguish one element from another.

The terms “front”, “back”, “bottom”, and/or “top” are used herein, unless otherwise noted, merely for convenience of description, and are not limited to any one position or spatial orientation.

The endpoints of all ranges directed to the same component or property are inclusive of the endpoints, are independently combinable, and include all intermediate points. For example, ranges of “up to 25 N/m, or more specifically 5 to 20 N/m” are inclusive of the endpoints and all intermediate values of the ranges of “5 to 25 N/m,” such as 10 to 23 N/m.

Unless defined otherwise, technical and scientific terms used herein have the same meaning as is commonly understood by one of skill in the art to which this invention belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While embodiments of the present disclosure have been particularly shown and described with reference to certain examples and features, it will be understood by one skilled in the art that various changes in detail may be effected therein without departing from the spirit and scope of the present disclosure as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. A system for particle detection within a chamber, comprising:
a transmitter configured to generate a beam of light;
one of a multipass configuration and beam shaping optics associated with the laser for generating a beam area within the chamber, the beam area configured to be arranged at an oblique angle relative to a longitudinal axis of the chamber and substantially confined to an imaging plane; and
a detector configured to detect particles that interact with the beam of light at the imaging plane.

2. The system according to claim 1, wherein the system comprises the multipass configuration comprising at least one of a curved mirror, a retroreflective mirror, and a combination thereof.

3. The system according to claim 1, wherein the system comprises the beam shaping optics configured to generate a rectangular ribbon shape of light.

4. The system according to claim 1, wherein the oblique angle is in a range from about 30 degrees to about 60 degrees.

5. The system according to claim 1, wherein the chamber has an inner diameter, and the beam area extends through about 25% to about 90% of the inner diameter of the chamber.

6. The system according to claim 1, wherein the system is configured to match the beam area to an inner diameter of the chamber.

7. The system according to claim 1, wherein the system is configured to detect a particle size of less than about 100 nm using optical emission.

8. The system according to claim 1, wherein the detector is configured to provide spatial information about the detected particles.

9. The system according to claim 1, wherein the transmitter is configured to be mechanically coupled to a wall of the chamber and optically coupled via a transmitter window to transmit the beam of light to the chamber, and wherein the detector is configured to be mechanically coupled to the wall of the chamber and optically coupled via a detector window to receive light from the particles as they pass through the beam area.

10. A system for particle detection within a pipe, comprising:
a transmitter configured to generate a beam of light;
a multipass configuration associated with the laser, wherein the multipass configuration comprises at least one curved mirror and at least one retroreflective mirror, and wherein multipass configuration generates a beam area within the pipe arranged at an oblique angle relative to a longitudinal axis of the pipe; and
a camera configured to detect one or more particles that traverse the beam area and interact with the beam of light, wherein the camera is positioned substantially perpendicular to the imaging plane.

11. The system according to claim 10, wherein the beam area is substantially confined to the imaging plane.

12. The system according to claim 10, wherein the system is installed in a section of a vacuum pump line fluidly connecting a process chamber with a vacuum pump system.

13. The system according to claim 12, wherein the section of the pipe comprises a mounting assembly that connects a first end of the pipe section to the process chamber and connects a second end of the pipe section to the vacuum pump system.

14. A method for particle detection within a chamber, comprising the steps of:
emitting a beam of light via a laser source into the chamber;
generating a beam area in the chamber by one of fanning out the beam of light or utilizing mirrors to generate a multi-pass structure;
tilting the beam area such that it is arranged at an oblique angle relative to a longitudinal axis of the chamber;
substantially confining the beam area to an imaging plane; and
detecting, with a detector, particles that interact with the beam of light at the imaging plane.

15. The method according to claim 14, wherein the step of generating the imaging plane comprises utilizing the multi-pass structure comprising at least one of a curved mirror, a retroreflective mirror, and a combination thereof, wherein the beam of light is bounced back and forth within the beam area a plurality of times.

16. The method according to claim 14, wherein the oblique angle is in a range from about 30 degrees to about 60 degrees.

17. The method according to claim 14, further comprising the step of matching the imaging plane to an inner diameter of the chamber.

18. The method according to claim 14, further comprising detecting one or more particles with a particle size of about 100 nm or less via the detector by detecting light emitted by the one or more particles that interact with the beam of light using optical emission.

19. The method according to claim 14, further comprising the step of providing spatial information about the detected particles via the detector.

20. The method according to claim 14, further comprising positioning the detector substantially perpendicular to the imaging plane to detect a light scattered from the detected particles that traverse the beam area.
